(19) United States
(12) Patent Application Publication
(10) Pub. No.: US 2010/0288099 A1
(43) Pub. Date: Nov. 18, 2010

(54) SAW BLADE

(76) Inventor: Marco Steiger, Bottighofen (CH)

Correspondence Address: VOLPE AND KOENIG, P.C., UNITED PLAZA, 30 SOUTH 17TH STREET, PHILADELPHIA, PA, 19103, US

(21) Appl. No.: 12/781,154

(22) Filed: May 17, 2010

(30) Foreign Application Priority Data
May 15, 2009 (CH) 00763/09

(51) Int. Cl. B23D 61/18

(52) U.S. Cl. 83/846

(57) ABSTRACT

A saw blade (5) for a machine tool (1) with oscillating drive includes toothing with teeth (7) whose tips lie on an arc (9a, 9b), with the centers Z₂ of the arc (9a, 9b) lying outside of a center of rotation Z₁ of the saw blade (5).

### CROSS-REFERENCE TO RELATED APPLICATIONS

This application claims the benefit of Swiss Patent Application No. 00763/09, filed May 15, 2009, which is incorporated herein by reference as if fully set forth.

### BACKGROUND

The present invention is directed to a saw blade for a machine tool.

Saw blades for oscillating machine tools are known, for example, from EP 0881023. The teeth are arranged in a straight line running tangential to the center of rotation of the saw blade. From EP 0881 023 it is further known to arrange the teeth in two straight lines that run at an obtuse angle and that intersect at the center axis or axis of symmetry. In the latter arrangement, the outermost teeth lie at the same radial distance to the tooth at which the two straight lines intersect. The teeth lying in-between consequently have a smaller radial distance from the center of rotation than the teeth lying on the outside.

These teeth arrangements have the disadvantage that the outermost-lying teeth are led into engagement with the work piece before the teeth lying on the straight intermediate regions. This can lead to an unclean cutting line according to the creation of the work piece.

### SUMMARY

One objective of the present invention is to provide a tooth geometry for a saw blade, wherein this tooth geometry eliminates the disadvantages of the known saw blades and allows a clean and also quick cut at a low pressure especially when penetrating/sawing into a flat surface.

This objective is met by a saw blade with the features of the invention

Through at least one tooth that is arranged in the center of the row of teeth and that projects past the adjacent teeth in the radial direction, it is possible to begin the saw cut essentially in the center of its length and to drop in successively. The chips cut out from the work piece by the central saw tooth can be discharged to the side and are no longer led through the notch by the adjacent teeth. The adjacent teeth somewhat offset in the radial direction bite into the work piece very softly and in succession and allow an extremely clean cutting line.

In particular, the side edge of the notch is cut very cleanly by the last teeth that are offset in the radial direction.

### BRIEF DESCRIPTION OF THE DRAWINGS

The invention is explained in more detail with reference to an illustrated embodiment. In the drawings:

FIG. 1 is a top view onto a machine tool with a saw blade that is mounted on this tool and that can be driven in an oscillating manner according to the prior art,

FIG. 2 is a view of a saw blade according to the prior art with teeth lying on straight lines at an obtuse angle relative to each other,

FIG. 3 is a view of a saw blade according to the invention with at least one saw tooth that lies in the center and that projects past the adjacent peaks in the radial direction,

FIGS. 4a and 4b are views of a cutout from the rows of teeth to the right and to the left of the middle tooth (for the sake of simplicity, all of the teeth are shown as the same size), and

FIG. 5 is a view of a cutout from the row of teeth in an additional construction with active tooth geometries on both sides.

### DETAILED DESCRIPTION FO THE PREFERRED EMBODIMENTS

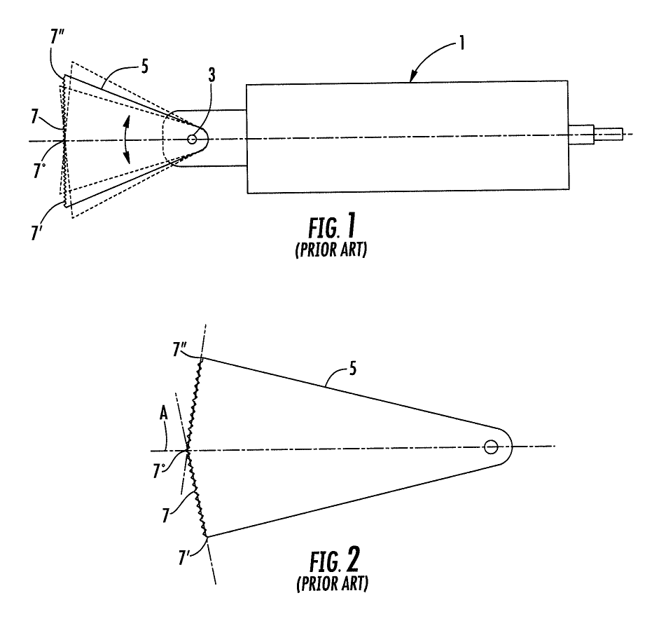

In FIG. 1, a machine tool is designated with reference symbol 1, with a saw blade 5 being set on its driven shaft 3. The saw blade 5 is driven by the driven shaft 3 in an oscillating manner (see the pivot extremes of the saw blade 5 indicated by dashed lines). The saw blade 5 has toothing 7 with the teeth lying in a straight line. Through this oscillation, the two outermost teeth 7′ and 7″ move on a circular arc section whose radius is significantly larger than the circular arcs on which the teeth lying in-between move.

In FIG. 2, the saw blade 5 is provided with a two-part toothing 7. The teeth there lie on two straight lines that cross at the center axis A. Through this measure, the outermost teeth 7′ and 7″ and also the tooth 7° lying at the center on the center axis A move on a common circular arc.

When penetrating into a flat plate, both for the saw blade 5 in FIG. 1 and also for the saw blade 5 in FIG. 2, the outermost teeth 7′ and 7″ impact essentially at a right angle to this plate, which can lead to an unclean cut.

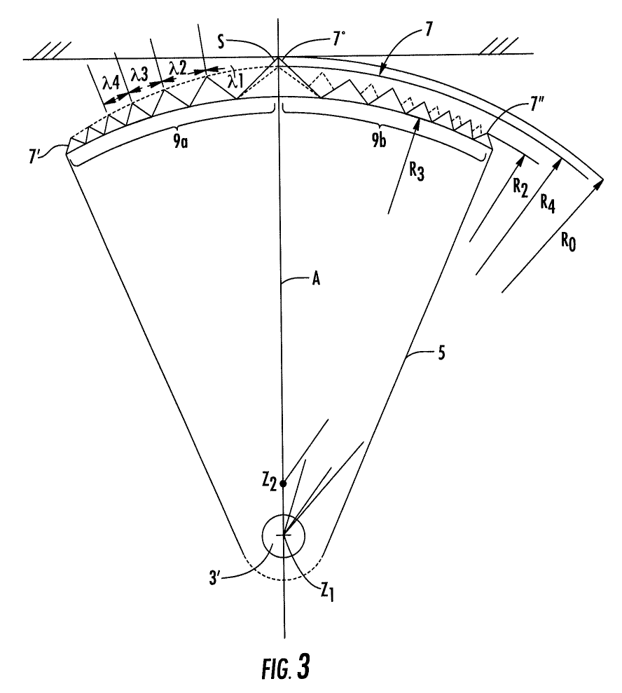

In FIG. 3, a saw blade 5 according to the invention is shown. The toothing is assembled here from a plurality of teeth 7 whose peaks lie on arcs 9a, 9b, advantageously circular arcs, with a radius R2. The center of rotation Z₂ of the two arcs 9a, 9b lies, e.g., above the center of rotation Z of the saw blade on the driven shaft 3 of the machine tool 1.

If the center of rotation Z₂ of the arcs 9a and 9b lies above the center of rotation Z₁ of the saw blade 5, then the radii R₂ are smaller than the radius R₁ or R₁ or R₀ of the peak S of a central tooth 7°. In contrast, if the centers Z₂ of the radii R₂ of the arcs are placed next to the pivot center Z₁ of the saw blade 5, then the radii R₂ of the arcs 9a and 9b are greater than the arcs R₁ and R₀, respectively.

The two arcs 9a, 9b with radius R₂ intersect at the center axis A. The at least one center tooth 7° lying on or very close to the center axis A lies at the intersection point of the two arcs with radius R₂ (tooth 7° is shown using dashed lines) and moves on an arc with R₁ or it projects with its tip S past the intersection point of the two arcs and, for an oscillating drive, moves on a circular arc section with radius R₀ about the center of rotation Z₁.

The tips between the center tooth 7° and the outermost teeth 7′ and 7″ that lie on the circular arcs 9a, 9b with radius R₂ begin close to the center axis A and become successively smaller, i.e., their roots have a smaller tangential length. The roots of the teeth can lie on a circular arc about the center Z with radius R₃. Obviously, all of the teeth lying outside of the center tooth 7° could have the same radial length, as long as their tips lie on arcs 9a, 9b with center Z₂. In general, the centers Z₂ of the arcs 9a, 9b lie outside of the center of rotation Z₁ of the saw blade 5.

In the schematic diagram of the saw blade 5 in FIG. 3, the teeth 7 are shown schematically as triangles for the sake of simplicity. In addition, only one row of teeth lying in a plane is visible. Obviously, a second row of teeth could be provided in an offset arrangement whose tips lie in the top view between the tips of the row of teeth lying in front. Such a second row of teeth lying offset and/or behind the first row of teeth is shown using dashed lines on the right half of the saw blade in FIG. 3.

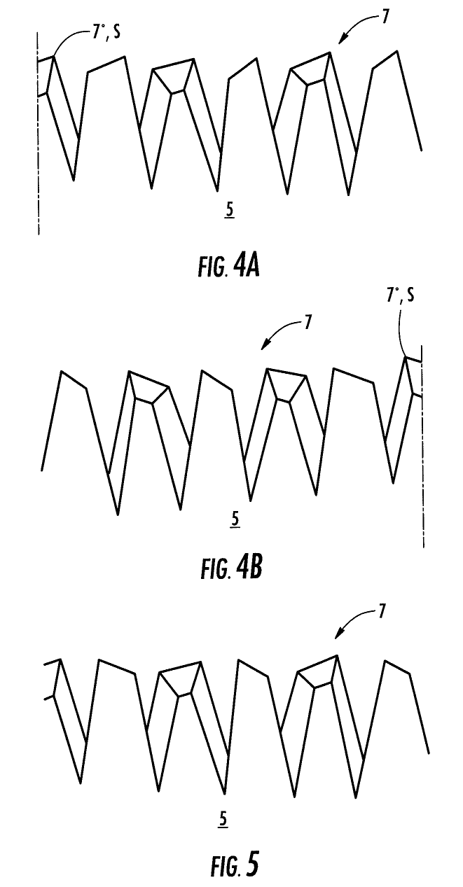

In FIGS. 4a and 4b, teeth 7 are shown with one possible tooth shape. For the sake of simplicity, the tips of the teeth 7 are arranged on a straight line and all have an equal height. According to the invention, however, their tips lie on arcs 9a, 9b. From FIGS. 4a and 4b it can be taken that, for example, the outer flanks of the teeth lie in the plane of the end surfaces of the saw blade 5 and their tips are cut inward at an angle. In this way it is achieved that the cutting edges can be cut very cleanly. For a construction of the teeth according to FIGS. 4a (right side of the saw blade 5) and FIG. 4b (left side of the saw blade), the cuts are each performed only in one direction.

In the diagram according to FIG. 5, the teeth are alternately cut in different directions, so that both for rotation to the left and also for rotation to the right, a cut is performed at approximately the same height.

The geometries shown in FIGS. 4 and 5 for the tooth cutting edges are shown purely as examples and other suitable cutting geometries adapted to the work piece to be processed could also be used.

The center tooth 7° could also be a double tooth, i.e., two teeth slightly offset relative to each other relative to axis A, wherein their cutting edges are formed opposite each other in two cutting directions (not shown).

In an additional construction of the invention, in particular, for very hard work pieces, the teeth could be produced as a whole or in part from a harder material than steel. The teeth could also be provided with suitable coatings.

### LEGEND

1 Machine tool
3 Driven shaft
5 Saw blade
7 Toothing
9 Arc

1. Saw blade (5) for a machine tool (1) with oscillating drive, comprising teeth (7) that are arranged mirror-symmetric to a center axis (A) of the saw blade (5), a tip S of a tooth or tooth pair (7°) lying on the center axis (A) is located in a radial direction farther away from a center of rotation Z₁ of the saw blade (5) than all of the other teeth (7′-7″).

2. Saw blade according to claim 1, wherein tips of the other teeth (7′-7″) lie on an arc-shaped line (9a, 9b).

3. Saw blade according to claim 2, wherein the tips of the other teeth (7′-7″) lie on a circular arc (9a, 9b) having a center Z₂ that is not identical to a center of rotation Z₁ of the saw blade (5) on each side of the center axis A.

4. Saw blade according to claim 1, wherein backs of the teeth (7° , 7′-7″) lie alternately on a front and a back surface of the saw blade (5).
